(19) United States
(12) Patent Application Publication
(10) Pub. No.: US 2025/0123457 A1
(43) Pub. Date: Apr. 17, 2025

(54) STRAY LIGHT STRIPPER FOR A COMBINER

(71) Applicant: Lumentum Operations LLC, San Jose, CA (US)

(72) Inventors: Gongwen ZHU, San Jose, CA (US); Guan SUN, San Jose, CA (US); Ning LIU, Morgan Hill, CA (US)

(21) Appl. No.: 18/392,426

(22) Filed: Dec. 21, 2023

Related U.S. Application Data
(60) Provisional application No. 63/590,585, filed on Oct. 16, 2023.

(51) Int. Cl. G02B 6/42; G02B 6/245; H01S 3/094; H01S 3/23

(52) U.S. Cl. CPC G02B 6/4296; G02B 6/245; H01S 3/094007; H01S 3/2383

(57) ABSTRACT

In some implementations, an optical fiber combiner includes a glass tube. A stray light stripper may be defined at a surface of the glass tube. The stray light stripper may be defined by perturbations in the surface of the glass tube or a layer of a material, on the glass tube, having a different refractive index than a refractive index of the glass tube. The perturbations may be grooves, notches, or etches. The optical fiber combiner may include a fiber bundle, disposed within the glass tube, including a plurality of optical fibers.

### CROSS-REFERENCE TO RELATED APPLICATION

This Patent Application claims priority to U.S. Provisional Patent Application No. 63/590,585, filed on Oct. 16, 2023, and entitled “STRAY LIGHT STRIPPER FOR A GLASS TUBE.” The disclosure of the prior Application is considered part of and is incorporated by reference into this Patent Application.

### TECHNICAL FIELD

The present disclosure relates generally to fiber lasers and to a stray light stripper for a combiner.

### BACKGROUND

Pump combiners and pump-signal combiners are important components of high-power fiber lasers. A pump combiner or pump-signal combiner combines light of input fibers to increase a total power of light emitted by a fiber laser.

### SUMMARY

In some implementations, an optical system includes a fiber oscillator or a fiber amplifier. The optical system may include an input system including a plurality of laser sources. The plurality of laser sources may include at least one of one or more first laser sources configured to generate signal light, or one or more second laser sources configured to generate pump light. The optical system may include an output fiber, optically coupled to the fiber oscillator or the fiber amplifier, including one or more cores configured to carry the signal light and a cladding, surrounding the one or more cores, configured to carry the pump light. The optical system may include an optical fiber combiner, arranged between the input system and the output fiber, including a glass tube, where a stray light stripper is defined at a surface of the glass tube. The optical fiber combiner may include a fiber bundle, disposed within the glass tube, including a plurality of optical fibers.

In some implementations, an optical fiber combiner includes a glass tube. A stray light stripper may be defined at a surface of the glass tube. The stray light stripper may be defined by perturbations in the surface of the glass tube or a layer of a material, on the glass tube, having a different refractive index than a refractive index of the glass tube. The perturbations may be grooves, notches, or etches. The optical fiber combiner may include a fiber bundle, disposed within the glass tube, including a plurality of optical fibers.

In some implementations, a method includes forming a stray light stripper on a glass tube, inserting a fiber bundle into the glass tube, where the fiber bundle includes a plurality of optical fibers, tapering a portion of the glass tube and a portion of the fiber bundle disposed within the glass tube, cleaving the fiber bundle, and splicing the fiber bundle to an output fiber.

### BRIEF DESCRIPTION OF THE DRAWINGS

FIG. 1 is a cross-sectional view of example combiners.

FIG. 2 illustrates an example combiner.

FIG. 3 is a top view of a portion of a glass tube having a stray light stripper.

FIG. 4 is a top view of a portion of a glass tube having a stray light stripper.

FIG. 5 illustrates an example optical system.

FIG. 6 is a flowchart of an example process associated with fabricating a combiner.

### DETAILED DESCRIPTION

The following detailed description of example implementations refers to the accompanying drawings. The same reference numbers in different drawings may identify the same or similar elements.

Combiners, such as pump combiners and pump-signal combiners, are important components of high-power fiber lasers. For example, a pump combiner generally combines pump light to create combined pump light with an increased power. In many cases, pump combiners are arranged in a bundle configuration, which is spliced to another optical structure (e.g., a master oscillator power amplifier (MOPA) and/or a single pass fiber laser structure) that is configured to deliver many hundreds of watts (W)/kilowatts (kW) of pump power. A bundle configuration can be achieved by arranging pump fibers into a particular close-packed configuration (e.g., a hexagonal close-packing configuration or the like), and fusing and tapering individual pump fibers into a bundle of a target size. Furthermore, in a pump-signal combiner, a signal fiber is included with the individual pump fibers in the bundle. In this way, the various pump fibers can be used to couple pump power from multiple pump sources into a cladding of an output fiber, and signal light can propagate through a core of the signal fiber included in the pump-signal combiner and into a core of the output fiber. Achieving stable and efficient packing of a bundle of optical fibers can be achieved by enclosing the bundle in a glass tube. Without using a glass tube, a number of optical fibers in a bundle and/or an arrangement of the optical fibers in the bundle may have constraints that would not apply when a glass tube is used.

A combiner that uses a glass tube may be included in a high-power fiber laser system in a backward pumping configuration or in a forward pumping configuration. In a backward pumping configuration, significant amounts of forward-propagating light of the system may propagate into a bundle of optical fibers of the combiner. Light in fiber cladding may then enter the glass tube, becoming undesirable stray light. In a forward pumping configuration, backward-propagating light of the system, due to backward amplified spontaneous emission (ASE), backward stimulated Raman scattering (SRS), backward stimulated Brillouin scattering (SBS), back reflection, or the like, may similarly enter the glass tube as stray light. The stray light in the glass tube may result in excessive heating of the combiner, which can damage fiber coatings and/or adhesives used to pack the bundle in the glass tube. Damage to the combiner may cause a performance of the high-power fiber laser system to suffer.

Some implementations described herein provide a stray light stripper on a glass tube of a combiner (e.g., a pump combiner, a pump-signal combiner, or a signal combiner). The stray light stripper may be defined by perturbations in a surface of the glass tube, such as grooves, notches, or etches. Additionally, or alternatively, the stray light stripper may be defined by a layer of material, applied on the glass tube, that has a different refractive index than a refractive index of the glass tube. The stray light stripper allows stray light in the glass tube to escape and scatter from the glass tube. In this way, overheating and damage to the combiner can be avoided, thereby improving a performance and a useful life of the combiner as well as improving a performance of a high-power (e.g., multi-kW) fiber laser system that includes the combiner.

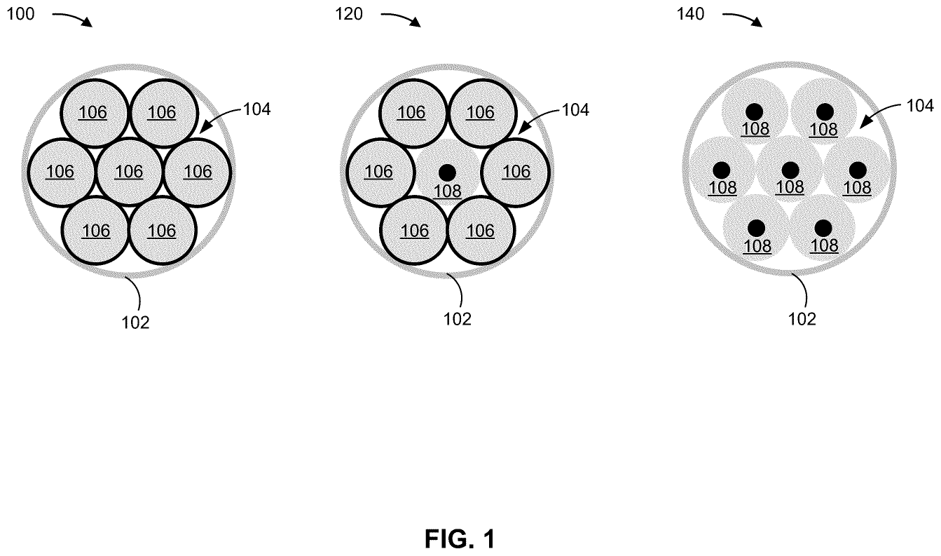

FIG. 1 is a cross-sectional view of example combiners 100, 120, and 140. The combiners 100, 120, and 140 can be used to scale power in multi-kW fiber lasers, as described herein. The combiners 100, 120, and 140 may be optical fiber combiners. The combiner 100 is shown as a pump combiner, the combiner 120 is shown as a pump-signal combiner, and the combiner 140 is shown as a signal combiner. Each combiner 100, 120, and 140 may include an enclosing tube 102 (e.g., a glass tube, a capillary tube, or the like) containing a fiber bundle 104. The fiber bundle 104 of the combiner 100 may include multiple pump fibers 106 (shown as a 7×1 pump combiner). The fiber bundle 104 of the combiner 120 may include a signal fiber 108 surrounded by multiple pump fibers 106 (shown as a (6+1)×1 pump-signal combiner). The fiber bundle 104 of the combiner 140 may include multiple signal fibers 108 (shown as a 7×1 signal combiner). Using an enclosing tube 102, almost any number of pump ports and/or signal ports are possible in a combiner.

In some implementations, a combiner (e.g., combiner 100, 120, or 140) may be manufactured by fusing several optical fibers into the fiber bundle 104, packing the fiber bundle 104 into the enclosing tube 102, and collapsing the enclosing tube 102 onto the fiber bundle 104. For example, optical fibers of the fiber bundle 104 may be packed into the enclosing tube 102, and the assembly may then be fused and tapered. The fused and tapered assembly may be size-matched in diameter to a core of an output fiber. The combiner bundle and the output fiber may then be spliced, completing the combiner.

As indicated above, FIG. 1 is provided as an example. Other examples may differ from what is described with regard to FIG. 1.

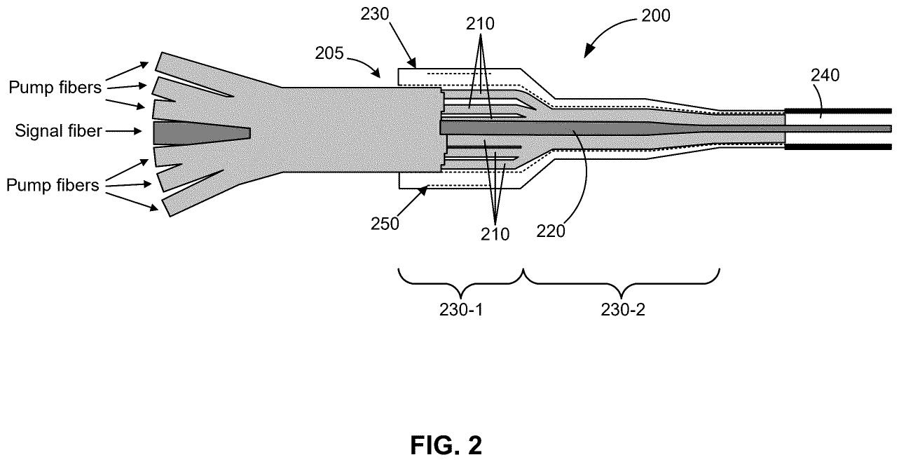

FIG. 2 illustrates an example combiner 200. The combiner 200 is an optical fiber combiner. The combiner 200 is shown in FIG. 2 as a pump-signal combiner. However, in some implementations, the combiner 200 may be a pump combiner or a signal combiner.

As shown in FIG. 2, the combiner 200 may include a fiber bundle 205 (e.g., corresponding to fiber bundle 104). The fiber bundle 205 includes a plurality of optical fibers 210, 220. For example, the fiber bundle 205 may include one or more pump fibers 210 and/or one or more signal fibers 220. As shown, the fiber bundle 205 includes a plurality of pump fibers 210 surrounding a signal fiber 220. In some implementations, the fiber bundle 205 may include a plurality of pump fibers 210 without a signal fiber 220. In some implementations, the fiber bundle 205 may include a plurality of signal fibers 220 without a pump fiber 210. The pump fiber(s) 210 may be arranged or configured to receive pump light from respective pump light sources (not shown). The signal fiber(s) 220 may be arranged or configured to receive signal light from respective signal light sources (not shown).

In some implementations, the pump fibers 210 and the signal fibers 220 may each include a fiber core that is circumferentially surrounded by a fiber cladding. Alternatively, in some implementations, a signal fiber 220 may not have a fiber cladding (e.g., the signal fiber 220 may have only a fiber core), or the signal fiber 220 may have a fiber cladding with a fiber cladding thickness that is different than respective fiber cladding thicknesses of the fiber claddings of the pump fibers 210. For example, the signal fiber 220 may have a fiber cladding with a fiber cladding thickness that is less than respective fiber cladding thicknesses of the fiber claddings of the pump fibers 210.

As further shown in FIG. 2, the combiner 200 may include a glass tube 230 (e.g., corresponding to enclosing tube 102). For example, the glass tube 230 may be a capillary tube (e.g., a hollow, open-ended glass tube). The glass tube 230 may have a circular cross section. The fiber bundle 205 may be disposed within the glass tube 230. For example, an internal region of the glass tube 230 may be defined by a space within the glass tube 230, such as a space between internal surfaces of one or more walls of the glass tube 230. Thus, the fiber bundle 205 may be disposed within the internal region of the glass tube 230 (e.g., the fiber bundle 205 may be inserted into and may fill (or substantially fill) the internal region of the glass tube 230). Furthermore, the combiner 200 may be coupled to an output fiber 240. The output fiber may include one or more cores configured to carry the signal light and a cladding, surrounding the one or more cores, configured to carry the pump light.

In some implementations, the pump fibers 210, the signal fibers 220, the glass tube 230, and the output fiber 240 may each comprise glass (e.g., a silica-based glass, a quartz-based glass, a fluorinated glass, or another type of glass). In some implementations, the pump fibers 210, the signal fibers 220, the glass tube 230, and the output fiber 240 may comprise the same glass types or different glass types.

As described above, light propagating into the optical fibers 210, 220 via the output fiber 240 (e.g., in a direction opposite to a light propagation direction of the combiner 200) may produce cladding light that can enter the glass tube 230. In some implementations, a stray light stripper 250 may be defined at a surface of the glass tube 230. The surface may be an inner surface and/or an outer surface of the glass tube 230. In some examples, the stray light stripper 250 may be formed prior to the fiber bundle 205 being inserted into the glass tube 230. For example, the stray light stripper 250 may be formed at the surface of the glass tube 230, and then the fiber bundle 205 may be inserted into the glass tube 230.

The stray light stripper 250 may be configured to strip stray light in the glass tube 230. For example, the stray light stripper 250 may be configured to strip stray light in the glass tube 230, without stripping pump light in the glass tube 230 (e.g., the stray light stripper 250 may be configured to selectively strip stray light in the glass tube 230). When the combiner 200 is used in a backward pumping configuration, forward-propagating light may propagate into the glass tube 230, becoming stray light. When the combiner 200 is used in a forward pumping configuration, backward-propagating light (e.g., due to backward ASE, backward SRS, backward SBS, back reflection, or the like) may propagate into the glass tube 230, becoming stray light. “Stripping” light from the glass tube 230 refers to causing the light to escape from the glass tube 230.

The stray light stripper 250 may be defined over an entirety of the surface of the glass tube 230, or over a region of the surface (e.g., that is smaller than the entirety of the surface) of the glass tube 230. As shown, the glass tube 230 may be tapered, which corresponds to a taper of the fiber bundle 205. The stray light stripper 250 may be defined at an untapered portion 230-1 of the glass tube 230 and/or at a tapered portion 230-2 of the glass tube 230. For example, the stray light stripper 250 may be defined solely at the untapered portion 230-1, or defined at the untapered portion 230-1 and the tapered portion 230-2.

As an example, for a signal combiner, the stray light stripper 250 may be defined anywhere on the surface of the glass tube 230 (e.g., because signal light is not intended to be guided in the glass tube 230). For a pump combiner or a pump-signal combiner, the stray light stripper 250 may be defined anywhere on the surface of the untapered portion 230-1 of the glass tube 230 and/or at a beginning of the tapered portion 230-2 of the glass tube 230 (e.g., where pump light does not leak to the glass tube 230). In other words, pump light may leak to a portion of the glass tube 230 where the pump light is guided by the glass tube 230, and the stray light stripper 250 may be defined anywhere on the surface of the glass tube 230 other than at the portion where the pump light is guided. As the pump fibers 210 are tapered, a numerical aperture of the light will increase, and the high-numerical-aperture light (e.g., above a threshold) will escape from the pump fibers 210 and leak into the glass tube 230 (e.g., the stray light stripper 250 may be located where the numerical aperture is below a threshold associated with pump light leaking into the glass tube 230).

In some implementations, the stray light stripper 250 may be defined by perturbations in the surface of the glass tube 230. The perturbations may be grooves, notches, etches, or other irregularities in the surface of the glass tube 230. Additionally, or alternatively, the perturbations may be tapers or other angular features in the surface of the glass tube 230 (e.g., produced by mechanical polishing of the glass tube 230).

Grooves and/or notches in the surface of the glass tube 230 may be produced using laser ablation (e.g., CO₂ laser ablation) on the glass tube 230. In some implementations, the grooves and/or notches may extend continuously, circumferentially around the glass tube 230. In some implementations, the grooves and/or notches may be arranged in one or more lines (e.g., where a “line” of grooves or notches refers to a sequence or pattern of grooves or notches extending linearly and lengthwise along the surface of the glass tube 230). In some implementations, multiple lines of grooves and/or notches may be located at various positions around a circumference of the glass tube 230. For example, the stray light stripper 250 may include multiple lines of grooves and/or notches, with a first line being centered at a 0° position, a second line being centered at a 90° position, a third line being centered at a 180° position, and a fourth line being centered at a 270° position with respect to a circumference of the glass tube 230. In some implementations, a line of grooves and/or notches may include straight lines, curved lines, and/or dots, among other examples. In some implementations, grooves in the surface of the glass tube 230 may have a zig-zag (e.g., oscillating, sinusoidal, or the like) pattern.

Etches in the surface of the glass tube 230 may be chemical etches. For example, etches in the surface of the glass tube 230 may be produced using chemical etching. The etches may have a regular pattern or a random pattern.

In some implementations, the stray light stripper 250 may be defined by a layer of material on the glass tube 230. The layer of material may have a different refractive index than a refractive index of the glass tube 230. For example, the layer of material may have a higher refractive index than a refractive index of the glass tube 230. The material may be a type of glass (e.g., a different type of glass than a type of glass of the glass tube 230) or a polymer.

As indicated above, FIG. 2 is provided as an example. Other examples may differ from what is described with regard to FIG. 2.

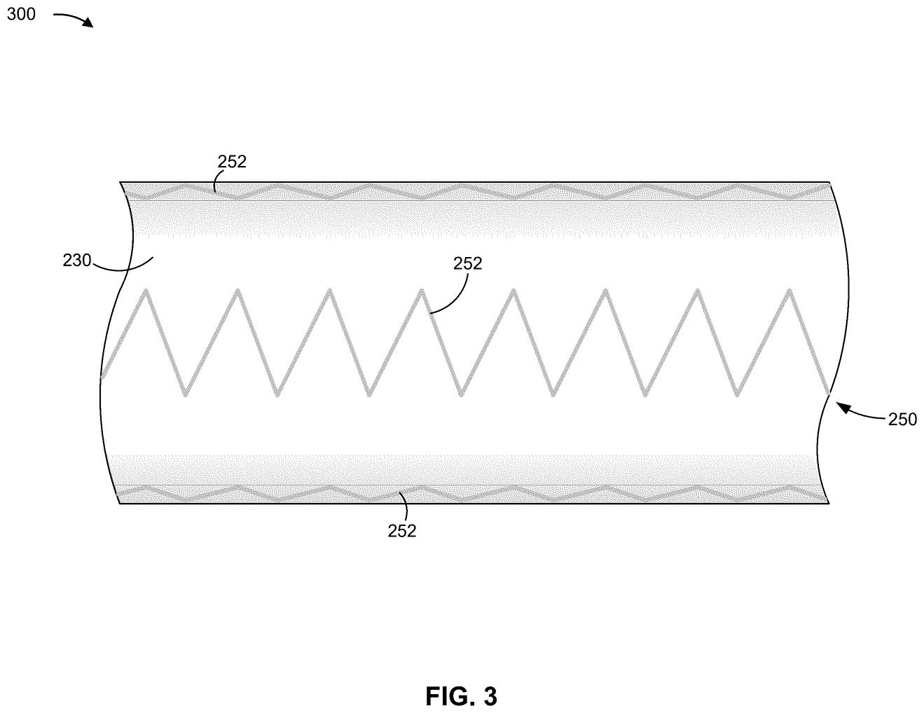

FIG. 3 is a top view of a portion of the glass tube 230 having the stray light stripper 250. As shown, the stray light stripper 250 may include multiple lines of grooves 252 in the surface of the glass tube 230. Each line of grooves 252 may have a zig-zag pattern, as described herein. The stray light stripper 250 may include a first line of grooves 252 and a second line of grooves 252 on opposing sides of the glass tube 230, and a third line of grooves 252 and a fourth line of grooves 252 on opposing sides of the glass tube 230 (e.g., respectively centered at a 0° position, a 90° position, a 180° position, and a 270° position with respect to a circumference of the glass tube 230).

As indicated above, FIG. 3 is provided as an example. Other examples may differ from what is described with regard to FIG. 3.

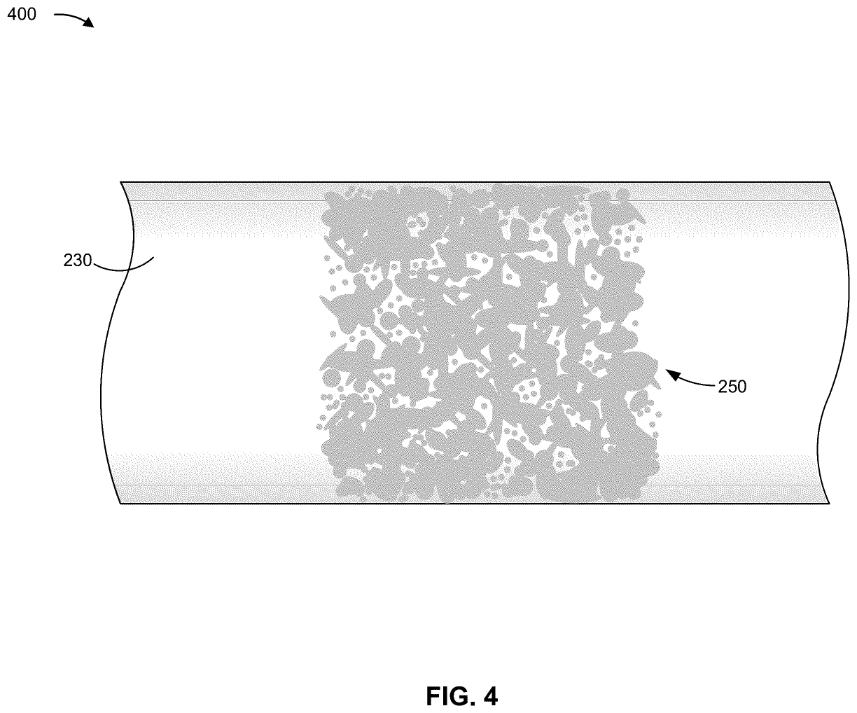

FIG. 4 is a top view of a portion of the glass tube 230 having the stray light stripper 250. As shown, the stray light stripper 250 may include etches in the surface of the glass tube 230, which may be produced using chemical etching. The stray light stripper 250 may include a contiguous etched region, or multiple discrete etched regions. In some implementations, an etched region may extend around a circumference of the glass tube 230.

As indicated above, FIG. 4 is provided as an example. Other examples may differ from what is described with regard to FIG. 4.

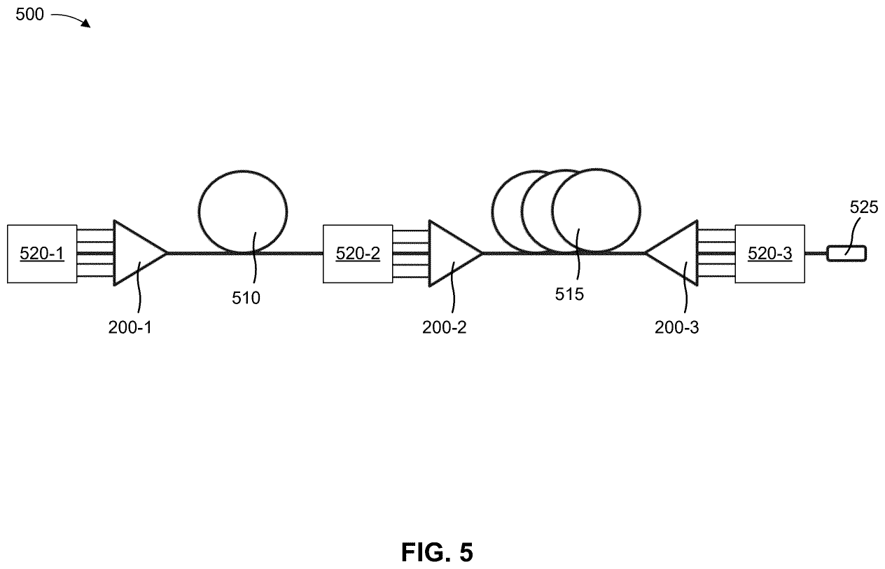

FIG. 5 illustrates an example optical system 500. The optical system 500 may be a fiber laser system and/or a fiber amplifier system. For example, the optical system 500 may be a high-power (e.g., multi-kW) fiber laser system. In some implementations, the optical system 500 may include a master oscillator power amplifier (MOPA) configuration.

The optical system 500 may include an active component (e.g., that produces optical gain and/or optical amplification). For example, the active component may include a fiber oscillator 510 and/or a fiber amplifier 515 (e.g., one or more fiber amplifiers 515). In the example shown, the optical system 500 includes the fiber oscillator 510 followed by the fiber amplifier 515 in a direction of light propagation of the optical system 500. The fiber oscillator 510 may include an active fiber. For example, a core of the active fiber may be doped with rare-earth ions, such as ytterbium ions and/or erbium ions. The active fiber may be arranged between fiber Bragg gratings (e.g., at an input end of the active fiber and at an output end of the active fiber) to form an optical cavity (i.e., an optical resonator) with the active fiber (e.g., for generating laser light). The fiber amplifier 515 may also include an active fiber (e.g., that is not part of an optical cavity), as described above.

As further shown in FIG. 5, the optical system 500 may include one or more sets of laser sources 520 and/or a laser output 525. For example, each set of laser sources 520 may define an input system of the optical system 500. Moreover, each set of laser sources 520 may include a plurality of laser sources. The plurality of laser sources, of a set of laser sources 520, may include one or more first laser sources configured to generate signal light and/or one or more second laser sources configured to generate pump light. For example, a set of laser sources 520 may include at least one first laser source configured to generate signal light and at least one second laser source configured to generate pump light. As another example, a set of laser sources 520 may include multiple second laser sources configured to generate pump light.

In the example shown, a first set of laser sources 520-1, corresponding to a first input system, may include one or more laser sources configured to provide signal light and/or one or more laser sources configured to provide first pump light, where the signal light and the first pump light is provided to a first combiner 200-1 (e.g., having a stray light stripper 250, as described herein) arranged between the first input system and an output fiber in an end pumping or forward pumping configuration. For example, as described herein, the output fiber may include one or more cores configured to carry the signal light and a cladding, surrounding the core, configured to carry the pump light. The output fiber may be optically coupled to the fiber oscillator 510. Accordingly, the combiner 200-1 may combine the signal light and the pump light provided by the first set of laser sources 520-1 to form first combined light (e.g., in a similar manner as described elsewhere herein). In some implementations, the first combiner 200-1 may be configured as a pump combiner.

In some implementations, the first combiner 200-1 may provide the first combined light to the fiber oscillator 510, which may provide the first combined light to a second combiner 200-2 (e.g., having a stray light stripper 250, as described herein). For example, as shown in FIG. 5, a second set of laser sources 520-2, corresponding to a second input system, may be configured to provide second pump light to the second combiner 200-2 arranged between the second input system and an output fiber in a cascaded pumping configuration. The output fiber may be optically coupled to the fiber amplifier 515. Accordingly, the second combiner 200-2 may combine the first combined light and the second pump light to form second combined light. The second combiner 200-2 may provide the second combined light to the fiber amplifier 515 (e.g., to one or more fiber amplifiers 515), which may amplify the second combined light and provide the second combined light to a third combiner 200-3 (e.g., having a stray light stripper 250, as described herein).

For example, as shown in FIG. 5, a third set of laser sources 520-3, corresponding to a third input system, may be configured to provide third pump light (e.g., that propagates in an opposite direction to a propagation direction of the second combined light) to the third combiner 200-3 arranged between the third input system and an output fiber in a counter pumping or backward pumping configuration. The output fiber may be optically coupled to the fiber amplifier 515. Accordingly, the third combiner 200-3 may combine the second combined light and the third pump light to form third combined light and provide the third combined light to the laser output 525 (e.g., that may emit the third combined light toward a target of the optical system 500).

As indicated above, FIG. 5 is provided as an example. Other examples may differ from what is described with regard to FIG. 5.

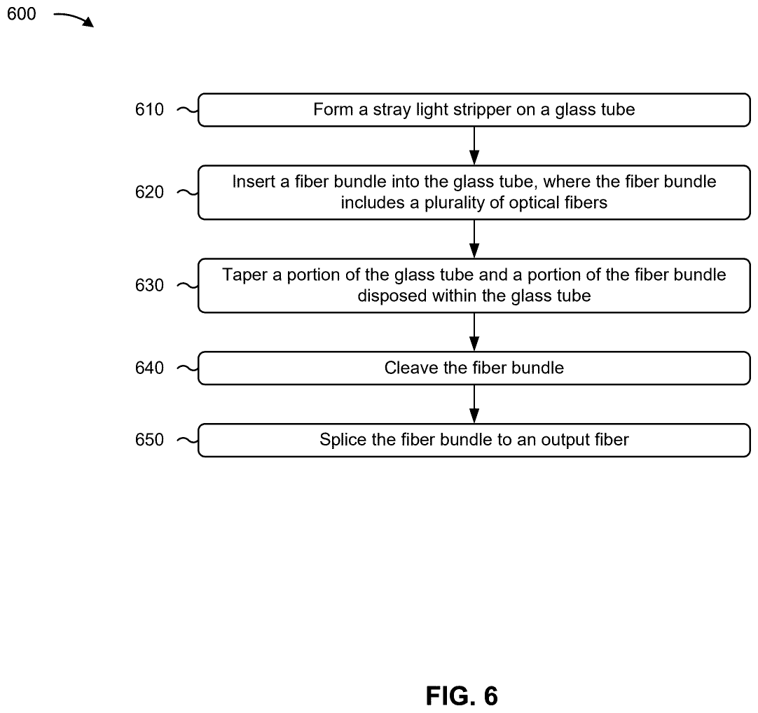

FIG. 6 is a flowchart of an example process 600 associated with fabricating a combiner. In some implementations, one or more process blocks of FIG. 6 are performed by a fabrication system. In some implementations, one or more process blocks of FIG. 6 are performed by another device or a group of devices separate from or including the fabrication system (e.g., another system or sub-system configured to prepare a stray light stripper, prepare a fiber bundle, prepare a tapered capillary tube, or the like).

As shown in FIG. 6, process 600 may include forming a stray light stripper on a glass tube (block 610). In some implementations, forming the stray light stripper may include etching a surface of the glass tube using a chemical etching process. Additionally, or alternatively, forming the stray light stripper may include forming grooves or notches in a surface of the glass tube using laser ablation.

As further shown in FIG. 6, process 600 may include inserting a fiber bundle into the glass tube, where the fiber bundle includes a plurality of optical fibers (block 620). The optical fibers may include one or more signal fibers and/or one or more pump fibers.

As further shown in FIG. 6, process 600 may include tapering a portion of the glass tube and a portion of the fiber bundle disposed within the glass tube (block 630). As further shown in FIG. 6, process 600 may include cleaving the fiber bundle (block 640). As further shown in FIG. 6, process 600 may include splicing the fiber bundle to an output fiber (block 650).

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical system, comprising:
a fiber oscillator or a fiber amplifier;
an input system comprising a plurality of laser sources that comprise at least one of:
one or more first laser sources configured to generate signal light, or
one or more second laser sources configured to generate pump light;
an output fiber, optically coupled to the fiber oscillator or the fiber amplifier, comprising one or more cores configured to carry the signal light and a cladding, surrounding the one or more cores, configured to carry the pump light; and
an optical fiber combiner, arranged between the input system and the output fiber, comprising:
a glass tube, wherein a stray light stripper is defined at a surface of the glass tube; and
a fiber bundle, disposed within the glass tube, comprising a plurality of optical fibers.

2. The optical system of claim 1, wherein the optical system comprises the fiber oscillator and the fiber amplifier,
wherein the optical fiber combiner is a first optical fiber combiner optically coupled to the fiber oscillator, and
wherein the optical system further comprises a second optical fiber combiner optically coupled to the fiber amplifier.

3. The optical system of claim 1, wherein the plurality of laser sources comprise at least one of the first laser sources configured to generate signal light and at least one of the second laser sources configured to generate pump light.

4. The optical system of claim 1, wherein the plurality of laser sources comprise a plurality of the second laser sources configured to generate pump light.

5. The optical system of claim 1, wherein the plurality of laser sources comprise a plurality of the first laser sources configured to generate signal light.

6. The optical system of claim 1, wherein the stray light stripper is defined by chemical etches in the surface of the glass tube or by grooves in the surface of the glass tube.

7. The optical system of claim 1, wherein the stray light stripper is configured to strip stray light in the glass tube without stripping pump light in the glass tube.

8. The optical system of claim 1, wherein the optical fiber combiner is arranged between the input system and the output fiber in a backward pumping configuration.

9. An optical fiber combiner, comprising:
a glass tube,
wherein a stray light stripper is defined at a surface of the glass tube,
wherein the stray light stripper is defined by perturbations in the surface of the glass tube or a layer of a material, on the glass tube, having a different refractive index than a refractive index of the glass tube, and
wherein the perturbations are grooves, notches, or etches; and
a fiber bundle, disposed within the glass tube, comprising a plurality of optical fibers.

10. The optical fiber combiner of claim 9, wherein the plurality of optical fibers comprise one or more signal fibers and one or more pump fibers.

11. The optical fiber combiner of claim 9, wherein the plurality of optical fibers comprise multiple pump fibers.

12. The optical fiber combiner of claim 9, wherein the plurality of optical fibers comprise multiple signal fibers.

13. The optical fiber combiner of claim 9, wherein the perturbations are chemical etches.

14. The optical fiber combiner of claim 9, wherein the perturbations are grooves in a zig-zag pattern.

15. The optical fiber combiner of claim 9, wherein the stray light stripper is defined at an untapered portion of the glass tube.

16. The optical fiber combiner of claim 9, wherein the stray light stripper is defined at an untapered portion of the glass tube and a tapered portion of the glass tube.

17. The optical fiber combiner of claim 9, wherein the perturbations comprise:
a first line of grooves in a zig-zag pattern centered at a 0° position with respect to a circumference of the glass tube;
a second line of grooves in a zig-zag pattern centered at a 90° position with respect to the circumference of the glass tube;
a third line of grooves in a zig-zag pattern centered at a 180° position with respect to the circumference of the glass tube; and
a fourth line of grooves in a zig-zag pattern centered at a 270° position with respect to the circumference of the glass tube.

18. A method, comprising:
forming a stray light stripper on a glass tube;
inserting a fiber bundle into the glass tube, wherein the fiber bundle comprises a plurality of optical fibers;
tapering a portion of the glass tube and a portion of the fiber bundle disposed within the glass tube;
cleaving the fiber bundle; and
splicing the fiber bundle to an output fiber.

19. The method of claim 18, wherein forming the stray light stripper comprises:
etching a surface of the glass tube using a chemical etching process.

20. The method of claim 18, wherein forming the stray light stripper comprises:
forming grooves or notches in a surface of the glass tube using laser ablation.
